(19) United States
(12) Patent Application Publication
(10) Pub. No.: US 2017/0371710 A1
(43) Pub. Date: Dec. 28, 2017

(54) DETECTING AND ENFORCING CONTROL-LOSS RESTRICTIONS WITHIN AN APPLICATION PROGRAMMING INTERFACE

(71) Applicant: International Business Machines Corporation, Armonk, NY (US)

(72) Inventors: ROBERT O. DRYFOOS, New Canaan, CT (US); CHRISTOPHER D. FILACHEK, Lagrangeville, NY (US); MICHAEL J. SHERSHIN, Poughkeepsie, NY (US)

(21) Appl. No.: 15/190,815

(22) Filed: Jun. 23, 2016

(51) Int. Cl. G06F 9/50; G06F 9/48

(52) U.S. Cl. CPC G06F 9/5011; G06F 9/4881

(57) ABSTRACT

The disclosed herein provides a method, system, and/or computer program product for determining control of a processing resource. To determine control of the processing resource, the method, system, and/or computer program can set a control-loss flag indicating whether a process has control of the processing resource and check the control-loss flag to determine whether the process lost control of the processing resource.

### BACKGROUND

In general, operating systems can provide application programming interfaces (APIs). A subset of APIs by definition does not release control of processing resources. Yet, because users can write code extensions to the operating systems and other product code through extension points or user exits, this subset APIs can be forced to relinquish control of their processing resources due to the code extension.

When an API is forced to relinquish control of its processing resource due to a code extension (i.e., via a corresponding extension point), errors can occur in the API because it no longer has control of processing resources. Further, when the API does not relinquish control and an extension point is called within the API, then the code extension does not gain proper control over that processing resource and the application calling the API can also experience errors. Examples of application errors include timeouts, deadlocks, resource depletion, and/or other illegal conditions. A way is needed to enforce control of processing resources with respect to extension points to avoid API and application errors.

### SUMMARY

According to one embodiment, a method of determining control of a processing resource is provided. The method comprises setting a control-loss flag indicating whether a process has control of the processing resource, and checking the control-loss flag to determine whether the process lost control of the processing resource. The method can be embodied in a system or a computer program product.

Additional features and advantages are realized through the techniques of the present disclosure. Other embodiments and aspects of the disclosure are described in detail herein. For a better understanding of the disclosure with the advantages and the features, refer to the description and to the drawings.

### BRIEF DESCRIPTION OF THE DRAWINGS

The subject matter is particularly pointed out and distinctly claimed in the claims at the conclusion of the specification. The forgoing and other features, and advantages of the embodiments herein are apparent from the following detailed description taken in conjunction with the accompanying drawings in which:

FIG. 1 illustrates a process flow of a system regarding setting a control-loss flag in accordance with an embodiment;

FIG. 2 illustrates a process flow of a system regarding a dispatch routine that checks a control-loss flag in accordance with another embodiment; and

FIG. 3 illustrates a processing system in accordance with an embodiment.

### DETAILED DESCRIPTION

The disclosure relates generally to detecting and enforcing control-loss restrictions within an application programmable interface (API). A control-loss restriction is an indication as to whether the API is permitted to relinquish control of a processing resource. More particularly, embodiments disclosed herein may include a system, a method, and/or a computer program product (herein collectively referred to as a system) that utilizes control-loss flags to detect and enforce the control-loss restrictions within the API including extension points or user exits.

A control-loss flag is a mechanism indicating whether a process within the system relinquished control (accidently or intentionally) of processing resources and/or other sensitive resources of the system. The control-loss flag can be a predefined bit or bit sequence that holds a value, which indicates a state/status that another program or process can utilize. The control-loss flag can be a Boolean mechanism or a multi-bit field or data area that can be set to an ON or OFF. For example, the control-loss flag can indicate ON, OFF, NULL, etc.). The ON status indicates that the process currently running is not allowed to relinquish control of a processing resource and should be monitored to determine if it does relinquish control. The OFF status indicates that the process is not monitored to determine if it relinquishes control. The NULL status can indicate that the control-loss flag is un-initialized or not associated with a process. The control-loss flag can be located in common storage of the system so that the system, APIs of the system, and user-written applications can access the control-loss flag. An example of the common storage includes a main memory of the system, such as a register in a virtual memory of the system accessible by all APIs and user-written applications.

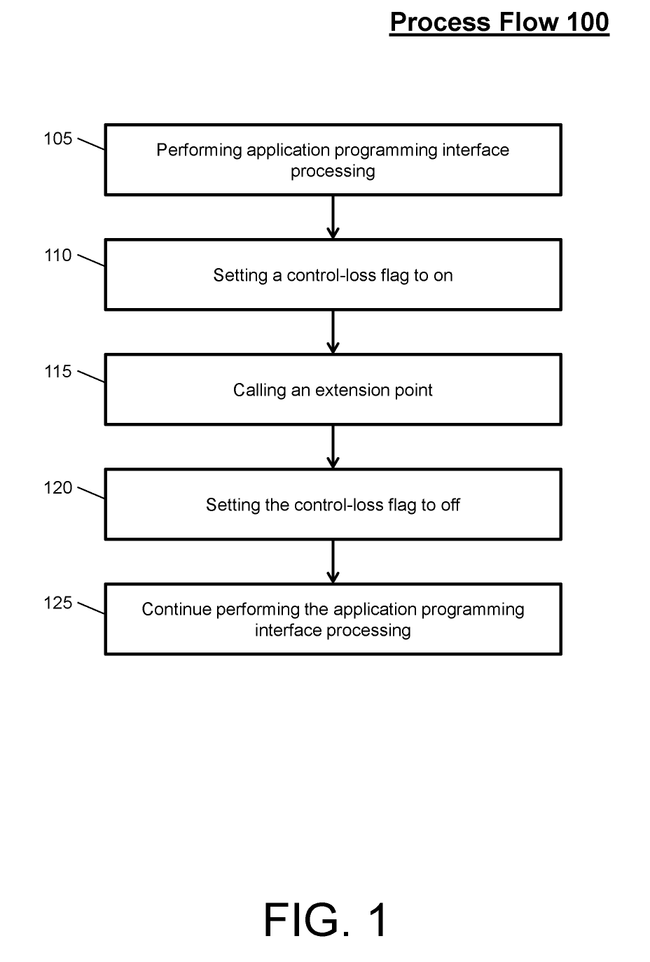

Turning now to FIG. 1, process flow 100 of the system is generally shown in accordance with an embodiment. The process flow 100 of the system illustrates an example of how the system sets a control-loss flag. Further, the process flow 100 can be applied to APIs that do not relinquish control and have extension points. The process flow 100 begins at block 105.

At block 105, the system performs a process. For example, the system can be an operating system utilizing a processor, the process can be any API processing within the operating system, and the processor can associate a register in its virtual memory with the API for storing the control-loss flag. In operation, the operating system performs an API processing. During the API processing, an extension point can be encountered by the operating system. Particularly, the operating system performs the API processing up to a location where the extension point exists. The location can vary within the API processing depending on a need of the API itself. Before calling the extension point, the process flow 100 proceeds to block 110.

At block 110, the system can turn ON a control-loss flag. Continuing with the above example, the operating system sets the control-loss flag in the virtual memory to on. This indicates that the API is calling an extension point and it should be monitored to determine if the extension point relinquishes control of the processor (e.g., can be set when a process enters a section or extension point that needs monitored to make sure it does not relinquish control). Note that the control-loss flag is the register of the API, in the virtual memory, is unique to the processor. In turn, if the processor is one of a plurality of processors accessible by the operating system, each processor can detect control loss independently.

Next, the process flow 100 proceeds to block 115, where the system can call an extension point. Continuing with the above example, the operating system can now utilize the processor to execute extension code associated with the extension point encountered in the API. When the extension code processing has concluded, control returns to the API and the API continue its operations.

At block 120, the system can turn OFF the control-loss flag. Continuing with the above example, the operating system sets the control-loss flag in the virtual memory to off to indicate that the extension code processing has concluded and this process no longer needs to be monitored for relinquish of control. Then, at block 125, the system can continue the process (e.g., the API processing) as needed.

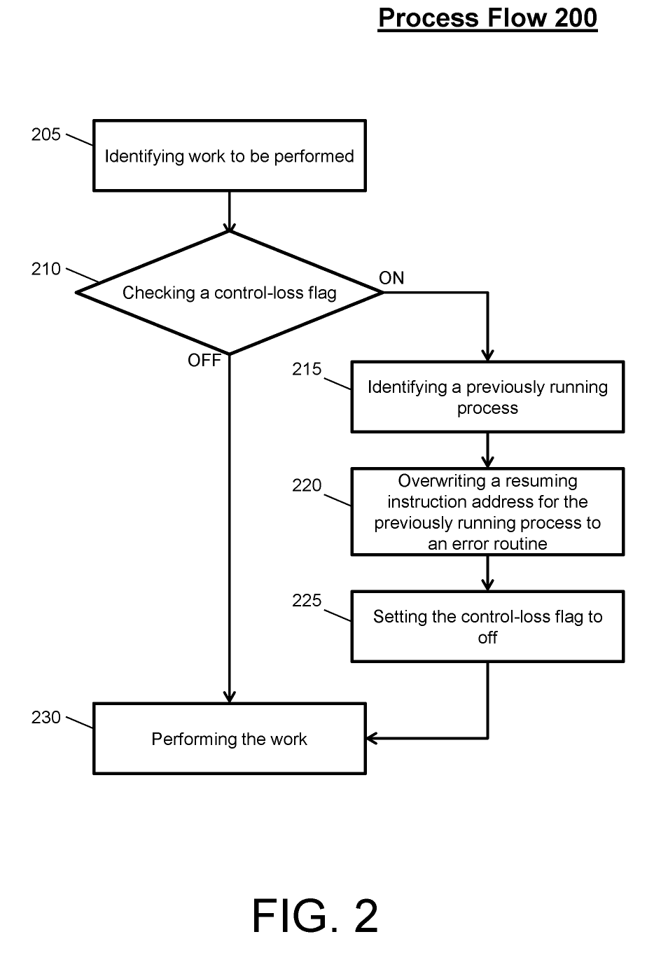

Turning now to FIG. 2, process flow 200 of the system is generally shown in accordance with an embodiment. The process flow 200 of the system illustrates an example of how a dispatch routine of the system checks a control-loss flag. In general, a dispatch routine handles one or more types of input/output (I/O) request packets to the system and assigns processing resources accordingly. The process flow 200 begins at block 205.

At block 205, the system identifies work to be performed. If work is identified, then the process flow proceeds to decision block 210 before performing the work. The work can be a new process, extension code, or a new API. For example, the identification of work can be initiated when an API of an operating system is going to relinquish control of a processing resource to an extension code due to an extension point being encountered during API processing.

At decision block 210, the system checks a control-loss flag. That is the dispatch routine checks the control-loss flag associated with the processing resource. If the control-loss flag is on, the process flow 200 proceeds to block 215 (as indicated by the ‘ON’ arrow).

At block 215, the system identifies a previously running process. To find the previously running process, the system searches in a specific register associated with that previously running process. The specific register can be assigned when the previously running process begins and, thus, is known to the system.

At block 220, the system overwrites (or sets) a resuming instruction address for the previously running process to an error routine address. In turn, when the previously running process regains control of the processing resource, the previously running process resumes execution with the error routine. The error routine can issue error messages and/or exit the previously running process so a user knows to correct the extension point (e.g., previous work can be tagged to go to an error routine to issue an error message and possibly exit the previous process).

At block 225, the system sets the control-loss flag to off. Next, the process flow 200 proceeds to block 230,

At block 230, the system performs the work. For instance, the operating system can start the new work on this processor as normal. Returning to block 210, if the control-loss flag is off, the process flow 200 proceeds to block 230 (as indicated by the ‘OFF’ arrow).

In addition to the above, the system can include exit processing (e.g., a routine exit and an error exit), which is a process that would update or turn off the control-loss flag without issuing any error messages. Further, the control-loss flag can be saved/restored when an extension point is interrupted by a debugger, thereby enabling users to debug the extension point.

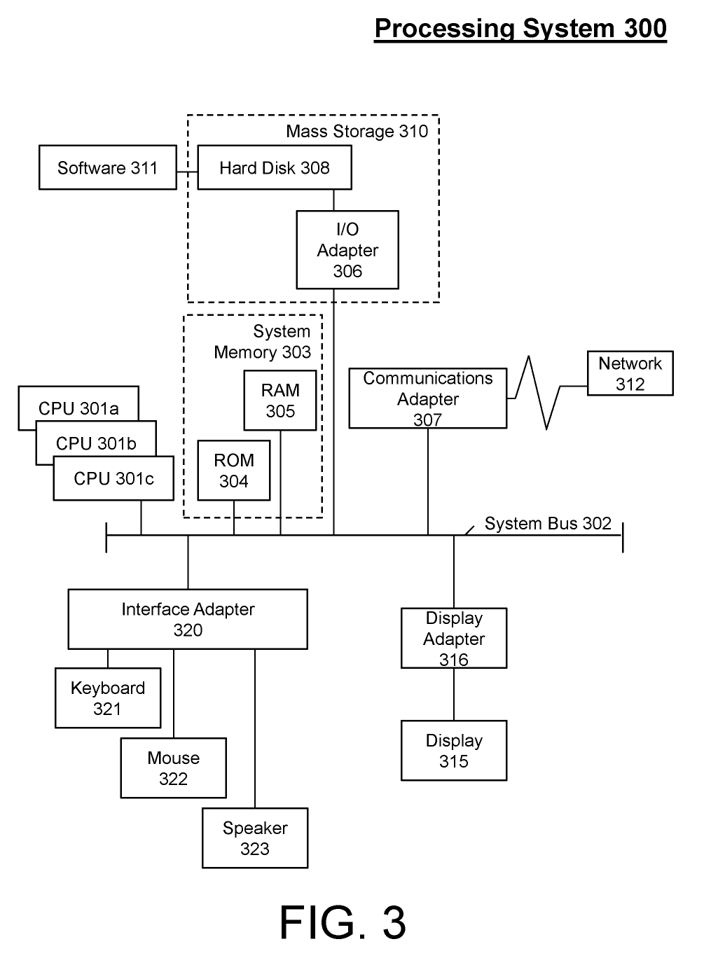

Referring now to FIG. 3, there is shown an embodiment of a processing system 300 for implementing the teachings herein. In this embodiment, the processing system 300 has one or more central processing units (processors) 301a, 301b, 301c, etc. (collectively or generically referred to as processor(s) 301). The processors 301, also referred to as processing circuits, are coupled via a system bus 302 to system memory 303 and various other components. The system memory 303 can include read only memory (ROM) 304 and random access memory (RAM) 305, either of which can be referred to as (or include) common storage or main memory that stores the control-loss flag. The ROM 304 is coupled to system bus 302 and may include a basic input/output system (BIOS), which controls certain basic functions of the processing system 300. RAM is read-write memory coupled to system bus 302 for use by processors 301.

FIG. 3 further depicts an input/output (I/O) adapter 306 and a network adapter 307 coupled to the system bus 302. I/O adapter 306 may be a small computer system interface (SCSI) adapter that communicates with a hard disk 308 or any other similar component. I/O adapter 306 and hard disk 308 are collectively referred to herein as mass storage 310. Software 311 for execution on processing system 300 may be stored in mass storage 310. The mass storage 310 is an example of a tangible storage medium readable by the processors 301, where the software 311 is stored as instructions for execution by the processors 301 to perform a method, such as the process flows of FIGS. 1 and 2. Network adapter 307 interconnects system bus 302 with an outside network 312 enabling processing system 300 to communicate with other such systems. A screen (e.g., a display monitor) 315 is connected to system bus 302 by display adapter 316, which may include a graphics controller to improve the performance of graphics intensive applications and a video controller. In one embodiment, adapters 306, 307, and 316 may be connected to one or more I/O buses that are connected to system bus 302 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 302 via an interface adapter 320 and the display adapter 316. A keyboard 321, mouse 322, and speaker 323 can be interconnected to system bus 302 via interface adapter 320, which may include, for example, a Super I/O chip integrating multiple device adapters into a single integrated circuit.

Thus, as configured in FIG. 3, processing system 300 can include processing capability in the form of processors 301, and, storage capability including the system memory 303 and mass storage 310, input means such as keyboard 321 and mouse 322, and output capability including speaker 323 and display 315. In one embodiment, a portion of system memory 303 and mass storage 310 collectively store an operating system, such as the z/OS or AIX operating system from IBM Corporation, to coordinate the functions of the various components shown in FIG. 3.

Technical effects and benefits include, if control of a processing resource by an application programmable interface is lost accidently or intentionally due to a user-written application, detection by an operating system of the loss of processing control, issuing by the operating system of an error message and/or terminate the user-written application. Thus, embodiments described herein are necessarily rooted in a processor executing an operating system to perform proactive operations to overcome problems specifically arising in the realm of application errors.

Embodiments may include a system, a method, and/or a computer program product at any possible technical detail level of integration. The computer program product may include a computer readable storage medium (or media) having computer readable program instructions thereon for causing a processor to carry out aspects of the embodiments herein.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the embodiments herein may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the embodiments herein.

Aspects of the embodiments are described herein with reference to flowchart illustrations and/or block diagrams of methods, apparatus (systems), and computer program products. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments herein. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

The descriptions of the various embodiments herein have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method of determining control of a processing resource, comprising:
setting a control-loss flag indicating whether a process has control of the processing resource; and
checking the control-loss flag to determine whether the process lost control of the processing resource.

2. The method of claim 1, wherein the setting the control-loss flag occurs when the process enters a section or an extension point that requires monitoring of whether the process relinquishes control.

3. The method of claim 1, wherein the control-loss flag comprises a predefined bit or bit sequence that holds a value indicating whether the process has control of the processing resource.

4. The method of claim 1, wherein the control-loss flag is located in a register of an application programming interface, the register being located in a virtual storage of the processing resource.

5. The method of claim 1, comprising:
performing a process via the processing resource.

6. The method of claim 5, wherein the process is a processing of an application programming interface executed by an operating system.

7. The method of claim 5, wherein the setting of the control-loss flag comprises:
setting the control-loss flag to off to indicate that the process does not require monitoring of whether the process relinquishes control.

8. The method of claim 7, comprising:
encountering an extension point of the process; and
setting the control-loss flag to on prior to calling the extension point.

9. The method of claim 8, comprising:
calling the extension point to execute an extension code via the processing resource.

10. The method of claim 1, wherein the checking of the control-loss flag is performed by a dispatch routine.

11. The method of claim 1, comprising:
overwriting a resuming instruction address for the process to an error routine when the control-loss flag is on.

12. A computer program product, the computer program product comprising a computer readable storage medium having program instructions for determining control of a processing resource embodied therewith, the program instructions executable by a processor to cause the processor to perform:
setting a control-loss flag indicating whether a process has control of the processing resource; and
checking the control-loss flag to determine whether the process lost control of the processing resource.

13. The computer program product of claim 13, wherein the setting the control-loss flag occurs when the process enters a section or an extension point that requires monitoring of whether the process relinquishes control.

14. The computer program product of claim 13, wherein the control-loss flag comprises a predefined bit or bit sequence that holds a value indicating whether the process has control of the processing resource.

15. The computer program product of claim 13, wherein the control-loss flag is located in a register of an application programming interface, the register being located in a virtual storage of the processing resource.

16. The computer program product of claim 13, wherein the program instructions are further executable by the processor to cause:
performing a process via the processing resource.

17. The computer program product of claim 16, wherein the process is a processing of an application programming interface executed by an operating system.

18. The computer program product of claim 16, wherein the setting of the control-loss flag comprises:
setting the control-loss flag to off to indicate that the process has control of the processing resource.

19. The computer program product of claim 18, wherein the program instructions are further executable by the processor to cause:
encountering an extension point of the process; and
setting the control-loss flag to on prior to calling the extension point.

20. A system, comprising a processor and a memory storing program instructions for determining control of a processing resource thereon, the program instructions executable by the processor to cause the system to perform:
setting a control-loss flag indicating whether a process has control of the processing resource; and
checking the control-loss flag to determine whether the process lost control of the processing resource.
